(19) United States
(12) Patent Application Publication
(10) Pub. No.: US 2005/0144490 A1
(43) Pub. Date: Jun. 30, 2005

(54) Electronic device with serial ATA interface and power saving method for serial ATA buses

(75) Inventor: Fubito Igari, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/018,931

(22) Filed: Dec. 22, 2004

(30) Foreign Application Priority Data
Dec. 25, 2003 (JP) 2003-431182

(51) Int. Cl. G06F 1/30

(52) U.S. Cl. 713/300

(57) ABSTRACT

An electronic device has a serial ATA interface and is connected to another electronic device through that serial ATA bus. A determination device determines whether immediate transmission of data is possible when the data should be transmitted to the another electronic device. A first mode switching device switches the serial ATA bus from a non power saving mode to a specific power saving mode when the immediate transmission of the data from the electronic device is determined to be impossible and the data is predicted as not being prepared within a preset time. A second mode switching device switches the serial ATA bus from the specific power saving mode to the non power saving mode after preparations are made for transmission of the data where the serial ATA bus is switched to the specific power saving mode.

### CROSS-REFERENCE TO RELATED APPLICATIONS

This application is based upon and claims the benefit of priority from prior Japanese Patent Application No. 2003-431182, filed Dec. 25, 2003, the entire contents of which are incorporated herein by reference.

### BACKGROUND OF THE INVENTION

1. Field of the Invention

The present invention relates to an electronic device with a serial ATA (AT Attachment) interface, and more particularly to an electronic device represented by a disk drive, and a power saving method for serial ATA (SATA) buses, which are suitable for reducing the power consumption of a serial ATA bus that conforms to the serial ATA interface standards.

2. Description of the Related Art

As recited in “Serial ATA: High Speed Serialized AT Attachment” Revision 1.0a, Serial ATA Workgroup, Jan. 7, 2003 (hereinafter referred to as “the prior art document”), standards for serial ATA interfaces that are new interfaces for disk drives have been worked out. Serial ATA interfaces are used as interfaces between a peripheral device, represented by a hard disk drive, and a host (host system) represented by a personal computer. In this point, serial ATA interfaces are similar to conventional ATA interfaces (i.e., parallel ATA interfaces).

A peripheral device having the serial interface (such as a hard disk drive HDD) is connected to the host by a serial ATA bus. The serial ATA bus comprises: a pair of signal lines that are connected to a differential amplifier configured to transmit signals in the first direction; and another pair of signal lines that are connected to another differential amplifier configured to transmit signals in the second direction (i.e., the direction opposite to the first direction). In such an HDD, to secure compatibility with an ATA interface, it is necessary to convert an ATA interface into a serial ATA interface, and convert a serial ATA interface into an ATA interface. Such interface conversion is performed by, for example, an LSI (bridge LSI) called a serial ATA interface control circuit (serial ATA bridge). A serial ATA interface control circuit is provided for the HDD.

In the serial ATA interface standards, three layers of different functions, i.e., a physical layer, a link layer and a transport layer, are defined. The physical layer has a function for executing high-rate serial data transmission and reception. The physical layer interprets received data, and transmits the data to the link layer in accordance with an interpretation result. The physical layer also outputs a serial data signal to the link layer in response to a request therefrom. The link layer supplies the physical layer with a request to output a signal. The link layer also supplies the transport layer with the data transmitted from the physical layer. The transport layer performs conversion for operations based on the ATA standards. Assuming that the above-mentioned serial ATA interface control circuit is used in an HDD, the role of the transport layer corresponds to the role of the ATA signal output unit of a conventional host that utilizes an ATA connection. The serial ATA interface control circuit is connected to the disk controller (HDC) of the HDD via an ATA bus (or a bus compliant with the ATA bus) based on the ATA interface standards. Accordingly, in the connection between the serial ATA interface control circuit and HDC of the HDD, operations equivalent to those stipulated in the ATA interface standards or compatible with the standards are performed. Thus, the serial ATA interface has compatibility with the ATA standards concerning protocols such as logical commands. However, a data signal (parallel data signal) processed by a parallel ATA interface must be converted into a serial data signal. Because of this conversion, the HDC regards the serial ATA interface control circuit as a host that issues commands to the HDC. The portion of the HDD excluding the serial ATA interface control circuit (hereinafter referred to as a “main HDD unit”) operates in the same manner as a conventional HDD utilizing an ATA connection.

In HDDs with serial ATA interfaces, a conventional ATA bus (i.e., parallel ATA bus) that connects a serial ATA interface control circuit to an HDC can be formed on the printed circuit board (PCB) of the HDD. Therefore, in HDDs with serial ATA interfaces, the wiring length of the ATA bus can be shortened, and hence an increase in data transfer rate, which is hard to realize if a parallel ATA bus is used, can be expected.

The serial ATA interface standards stipulate a power saving mode directed to serial ATA buses, as well as a power saving mode that conforms to the conventional ATA interface (parallel ATA interface) standards. The idea of serial ATA bus power saving does not exist in the conventional ATA standards. The serial ATA interface standards stipulate three power management modes for serial ATA interfaces, i.e., “PHY READY (IDLE)”, “PARTIAL” and “SLUMBER”. The “PHY READY” mode indicates a power saving state in which both the circuit (PHY circuit) for realizing the operation of a physical layer (PHY layer), and the main phase-locked loop (PLL) circuit are operating, thereby synchronizing the interfacing states of the host and peripheral device. The “PARTIAL” mode and “SLUMBER” mode indicate a power saving state in which the PHY circuit is operating but the interface signal is in a neutral state.

The difference by definition between the “PARTIAL” mode and “SLUMBER” mode lies in the time required for restoration therefrom to the “PHY READY (IDLE)” mode. More specifically, it is stipulated that the time required for restoration from the “PARTIAL” mode must not exceed 10 μs. On the other hand, it is stipulated that the time required for restoration from the “SLUMBER” mode must not exceed 10 ms. As long as the restoration time and interface power state conform to the standards, manufacturers can select the portion of a device, the power saving function of which should be executed in the “PARTIAL” mode or “SLUMBER” mode (i.e., can select the circuit that should be turned off in the mode).

As described above, the serial ATA interface standards have been worked out on the assumption that they are compatible with the conventional ATA standards (parallel ATA standards). Therefore, to realize the new idea of power saving stipulated in the serial ATA standards, it is necessary to provide a host with new means for designating new power saving. However, such new means may well deviate from the conventional ATA standards. Further, the provision of new means to a host may significantly influence the entire system.

Shift to a power saving (ATA power saving) state conforming to the conventional ATA interface standards is realized basically under the control of a host. As ATA power saving modes, “IDLE”, “STANDBY” and “SLEEP” modes, for example, are stipulated. On the other hand, shift to a power saving (serial ATA power saving) mode (i.e., the “PARTIAL” or “SLUMBER” mode) for a serial ATA bus may be realized under the control of either a host or peripheral device. It may be thought to control the power saving state of the serial ATA bus from the peripheral device. However, the above-mentioned prior art document describes nothing about a technique for controlling the serial ATA power saving state (in particular, a technique for associating the ATA power saving state with the serial ATA power saving state).

In the serial ATA standards, the interface conversion at the ends of the Serial ATA bus should not greatly differ from the interface conversion stipulated in the conventional ATA standards (parallel ATA interface standards). Let us assume that a host issues a command to a peripheral device. In this case, in the conventional ATA standards, the parallel ATA bus continues to be in the “BUSY” state until the host confirms that the operation designated by the command ends. One may think of performing interface conversion to set the serial ATA bus in the “BUSY” state then. However, the inventors of the present invention recognized that the serial ATA bus was not necessarily “BUSY” during the “BUSY” period of the parallel ATA bus. For example, the information exchange using the serial ATA bus is performed by use of frame information of serial data format, referred to as the Frame Information Structure (FIS). The serial ATA bus becomes actually “BUSY” during the FIS transmission/reception period and during the processing period related thereto. In short, the “BUSY” state of the parallel ATA bus does not necessarily mean that the serial ATA bus is “BUSY.”

### BRIEF SUMMARY OF THE INVENTION

In accordance with an embodiment of the invention, there is provided an electronic device comprising a serial ATA interface and connected to another electronic device through that serial ATA bus. The electronic device comprises: a determination device configured to determine whether immediate transmission of data is possible when the data should be transmitted to the another electronic device; a first mode switching device configured to switch the serial ATA bus from a non power saving mode to a specific power saving mode when the immediate transmission of the data from the electronic device is determined to be impossible and it is not predicted that the data can be prepared within a preset time; and a second mode switching device configured to switch the serial ATA bus from the specific power saving mode to the non power saving mode after preparations are made for the transmission of the data where the first mode switching device switches the serial ATA bus to the specific power saving mode.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a system that employs a hard disk drive (HDD) 10 according to an embodiment of the present invention.

FIG. 2 is a block diagram showing the main HDD unit 11 depicted in FIG. 1.

FIG. 3 is a sequence chart illustrating how the states of signals on SATA bus 30 and the power saving modes of SATA bus 30, ATA bus 13 and ATA bus 23 are in a first case where a host 20 issues a command (a read command) involving data transfer.

FIG. 4 is a flowchart illustrating operations which a SATA interface control circuit 12 performs in the first case described above.

FIG. 5 is a flowchart illustrating operations which are according to the first modification and which the SATA interface control circuit 12 performs in the first case described above.

FIG. 6 is a flowchart illustrating operations which are according to the second modification and which the SATA interface control circuit 12 performs in the first case described above.

FIG. 7 is a sequence chart illustrating how the states of signals on SATA bus 30 and the power saving modes of SATA bus 30, ATA bus 13 and ATA bus 23 are in a second case where the host 20 issues a command (a read command) involving data transfer and where it is necessary to send information on the type of data transfer from the HDD 10 to the host 20 before the designated data transfer is performed.

FIG. 8 is a flowchart illustrating operations which the SATA interface control circuit 12 performs in the second case described above.

FIG. 9 is a sequence chart illustrating how the states of signals on SATA bus 30 and the power saving modes of SATA bus 30, ATA bus 13 and ATA bus 23 are according to a modification in the second case described above.

FIG. 10 is a flowchart illustrating operations which the SATA interface control circuit 12 performs according to the modification in the second case described above.

FIG. 11 is a sequence chart illustrating how the states of signals on SATA bus 30 and the power saving modes of SATA bus 30, ATA bus 13 and ATA bus 23 are in a third case where the host 20 issues a command involving no data transfer.

FIG. 12 is a flowchart operations which the SATA interface control circuit 12 performs in the third case described above.

### DETAILED DESCRIPTION OF THE INVENTION

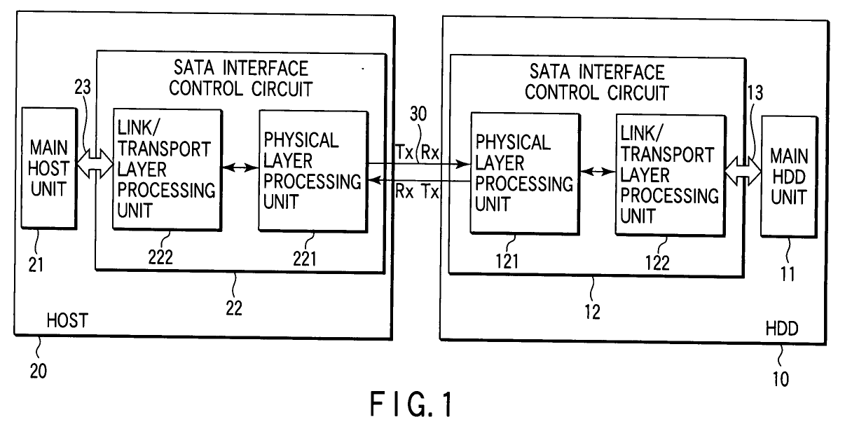

An embodiment in which the invention is applied to a system equipped with a hard disk drive having a serial ATA (SATA) interface will be described in detail with reference to the accompanying drawings. FIG. 1 is a block diagram illustrating the configuration of the system equipped with the hard disk drive (HDD) 10, according to the embodiment of the invention. As shown, the HDD 10 comprises a main HDD unit 11 and SATA interface control circuit 12. The main HDD unit 11 corresponds to a conventional HDD for performing parallel data transfer using an ATA interface. The SATA interface control circuit 12 is a SATA (serial ATA) bridge for peripheral devices. The SATA interface control circuit 12 is connected to a host (host system) 20 via a SATA bus (serial ATA bus) 30. The SATA interface control circuit 12 is used to perform interface conversion between an ATA interface and SATA interface, and is formed of, for example, a large-scale integrated circuit (LSI). The SATA interface control circuit 12 has, in particular, a function for converting an instruction, sent via the SATA bus 30, into an instruction suitable for an ATA bus 13 (ATA interface), and sending it to the main HDD unit 11 via the ATA bus 13.

The host 20 is an electronic device, such as a personal computer, which uses the HDD 10 as storage. The host 20 comprises a main host unit 21 and SATA interface control circuit 22. The main host unit 21 corresponds to a conventional host for performing parallel data transfer using an ATA interface. The SATA interface control circuit 22 is a host bridge, and is connected to the main host unit 21 via an ATA bus (parallel ATA bus) 23, and to the HDD 10 via the SATA bus (serial ATA bus) 30. The SATA interface control circuit 22 is formed of an LSI for performing interface conversion between an ATA interface and a SATA interface, like the SATA interface control unit 12 of the HDD 10. The SATA interface control circuit 22 has, in particular, a function for converting an instruction, sent via the ATA bus 23, into an instruction suitable for the SATA bus 30 (SATA interface), and sending it to the HDD 10 via the SATA bus 30.

The SATA interface control circuits 12 and 22 have physical layer processing units 121 and 221 and link/transport layer processing units 122 and 222, respectively. The physical layer processing units 121 and 221 execute high-rate serial data transfer (transmission/reception) via the SATA bus 30. At this time, the data transfer rate is 1.5 Gbps (gigabits per second). The physical layer processing units 121 and 221 interpret data received from the SATA bus 30, and transmits the data to the link/transport layer processing units 122 and 222 in accordance with the interpretation results, respectively. Further, the physical layer processing units 121 and 221 transmit respective serial data signals in response to requests from the link/transport layer processing units 122 and 222, respectively. The link/transport layer processing units 122 and 222 each include a link layer processing unit and transport layer processing unit, which are not shown. The respective link layer processing units of the link/transport layer processing units 122 and 222 supply the physical layer processing units 121 and 221 with requests to output signals, in response to requests from the transport layer processing units of the processing units 122 and 222. Further, the respective link layer processing units of the processing units 122 and 222 supply the respective transport layer processing units with data transmitted from the physical layer processing units 121 and 221. The transport layer processing units perform interface conversion between the ATA interface and SATA interface.

Buses, such as peripheral component interconnect (PCI) buses, compatible with the ATA buses 13 and 23 may be employed instead of the ATA buses 13 and 23. In this case, the SATA interface control circuits 12 and 22 can be provided in a PCI bridge. Further, it is sufficient if the SATA interface control circuits 12 and 22 (SATA bridges) have a function for transmitting and receiving serial ATA interface signals to and from the SATA bus 30.

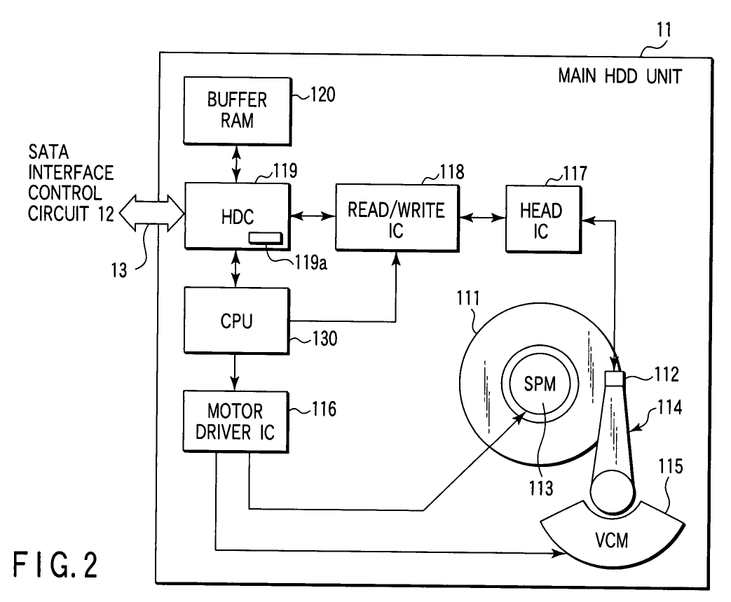

FIG. 2 is a block diagram illustrating the configuration of the main HDD unit 11. The main HDD unit 11 has a disk 111 as a recording medium. At least one surface of the disk 111 is a recording surface on which data is magnetically recorded. A head (magnetic head) 112 opposes the at least one recording surface of the disk 111. FIG. 2 shows a case where the main HDD unit 11 (HDD 10) includes only one head 112, for facilitating the drawing of the figure. However, in general, both surfaces of the disk 111 serve as recording surfaces, which respective heads oppose. Further, in the example of FIG. 2, it is assumed that the main HDD unit 11 (HDD 10) includes a single disk 111. However, it may include a plurality of disks 111 stacked on each other.

The disk 111 is spun at high speed by a spindle motor (SPM) 113. The head 112 is used to read and write data from and to the disk 111. The head 112 is attached to the tip of an actuator 114. The actuator 114 has a voice coil motor (VCM) 115. The actuator 114 is driven by the VCM 115, thereby radially moving the head 112 over the disk 111. As a result, the head 112 is positioned on a target track. The SPM 113 and VCM 115 are powered by respective driving currents (SPM current and VCM current) supplied from a motor driver IC 116. The motor driver IC 116 supplies the SPM 113 with an SPM current designated by a CPU 130, and supplies the VCM 115 with a VCM current designated by the CPU 130.

The head 112 is connected to a head IC (head amplifier circuit) 117. The head IC 117 includes a read amplifier for amplifying a read signal read by the head 112, and a write amplifier for converting write data into a write current. The head IC 117 is connected to a read/write IC (read/write channel) 118. The read/write IC 118 is a signal processing device for performing various kinds of signal processing such as analog-to-digital conversion of a read signal, encoding of write data, decoding of read data, etc. The read/write IC 118 is connected to a hard disk controller (HDC) 119.

The HDC 119 has a disk control function for controlling data transfer from and to the disk 111. The HDC 119 includes an ATA interface. That is, the HDC 119 has an ATA interface control function for receiving and transmitting commands (such as read/write commands) and data from and to the host 20 via the ATA bus 13. However, in the embodiment that includes the HDD 10 having a SATA interface, the HDC 119 is connected to the SATA interface control circuit 12 via the ATA bus 13, which differs from conventional HDDs. The HDC 119 is connected to the host 20 via the SATA interface control circuit 12 and SATA bus 30. The HDC 119 has a buffer control function for controlling a buffer RAM 120. A part of the memory area of the buffer RAM 120 is used as a data buffer area for temporarily storing data transferred between the host 20 and the HDC 119 of the HDD 10. The HDC 119 manages the information representing the correspondence between the data stored in the buffer RAM 120 and the disk addresses (logical addresses) of the data. The HDC 119 includes a status register 119a used for reporting the state of the HDD 10 to the host 20.

The CPU 130 is a main controller in the main HDD unit 11 (HDD 10). The CPU 130 includes a flash ROM (FROM) 130a. The FROM 130a is a rewritable nonvolatile memory in which a control program is stored in advance. Based on the stored control program, the CPU 130 controls each element in the HDD 10.

An operation of the system shown in FIG. 1 (mainly an operation of the HDD 10 thereof) will now be described, referring to the case where only a command execution result is sent from the HDD 10 to the host 20. In the descriptions below, reference will be made to (1) the case where the command involves data transfer; (2) the case where the command involves data transfer, and data indicating the type of data transfer is sent from the HDD 10 to the host 20 prior to the data transfer; and (3) the case where the command does not involve data transfer.

(1) The Case where the Command Involves Data Transfer

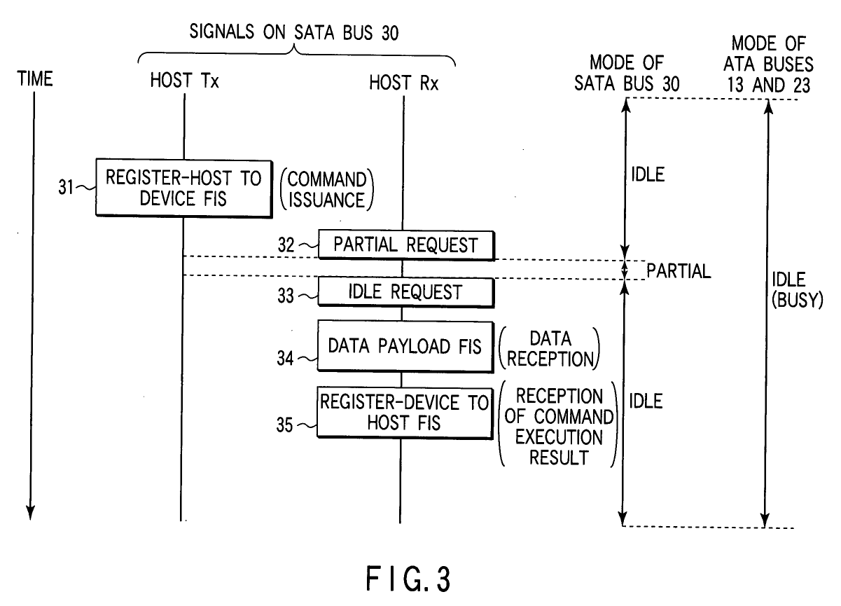

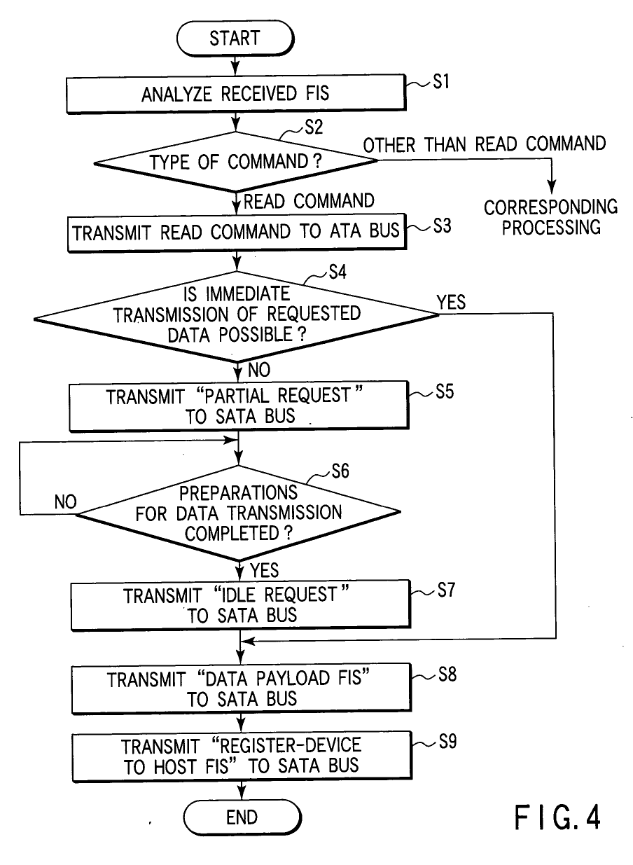

A description will be given with reference to the sequence chart of FIG. 3 and the flowchart of FIG. 4 as to how operations are performed when a command involving data transfer (e.g., a read command) is issued from the host 20. FIG. 3 shows how a signal (“Host Tx” signal) the host 20 transmits to the SATA bus 30 and a signal (“Host Rx” signal) the host 20 receives from the SATA bus 30 are correlated to the power saving modes of SATA bus 30, ATA bus 13 and ATA bus 23. FIG. 4 illustrates operations which the SATA interface control circuit 12 of the HDD 10 performs.

Let us assume that a read command conforming to the ATA standards and addressed to the HDD 10 is supplied from the main host unit 21 of the host 20 to the ATA bus 23, and that the read command is a read DMA command that instructs direct memory access (DMA) transfer of read data. The read command on the ATA bus 23 is received by the SATA interface control circuit 22 of the host 20. The link/transport layer processing unit 222 of the SATA interface control circuit 22 converts the command it receives into a specific frame instruction structure (FIS) based on the SATA standards. The command from the ATA bus is converted into specific FIS 31 referred to as “Register-Host to Device FIS.” The FIS 31 is a sequence of serial data. Information regarding the read command is contained in the FIS 31. The FIS (“Register-Host to Device FIS”) 31 is transmitted to the HDD 10 by way of the SATA bus 30.

The SATA interface control circuit 12 of the HDD 10 receives the FIS (“Register-Host to Device FIS”) 31 transmitted thereto through the SATA bus 30. The link/transport layer processing unit 122 of the SATA interface control circuit 12 analyzes the received FIS 31 (Step S1). Based on the content of the FIS 31, the link/transport layer processing unit 122 determines whether a data read is commanded by the host 20 (Step S2). If this is the case, the link/transport layer processing unit 122 converts the received FIS 31 into a command (a read command in the present embodiment) conforming to the ATA standards, and transmit it to the ATA bus 13 (Step S3).

The link/transport layer processing unit 122 determines whether the data requested by the read command corresponding to the FIS 31 can be immediately transmitted to the host 20 (Step S4). This determination is made by causing the link/transport layer processing unit 122 to inquire to the HDC 119 whether the corresponding data is stored in the buffer RAM 120. The reason for making the determination in this way is that the HDC 119 manages the information representing the correlation between the data stored in the buffer RAM 120 and the disk addresses (logical addresses). If the link/transport layer processing unit 122 retains a copy of this information, the inquiry described above need not be performed. Incidentally, in order to transfer data from the HDD 10 to the host 20 by way of the ATA bus 13, a specific FIS referred to as “Data Payload FIS” is used. The number of bytes of the data which can be transferred by use of the “Data Payload FIS” is an integer multiple of “4” (the data is comprised of at least four bytes). Therefore, as long as data of at least four bytes is stored in the buffer RAM 120, the data can be immediately transmitted to the host 20.

Let us assume that the HDD 10 is not ready to transmit to the host 20 the data requested by the read command corresponding to the received FIS 31. In this case, the data requested by the read command has to be read out from the disk 111. This operation includes a seek operation and a wait operation. The seek operation is an operation for moving the head 112 to a target track on the disk 111. The wait operation is required before the target sector of the disk 111 is rotated to the position of the head 112 after the head 112 is moved to the target track. In general, the seek and wait operations require several milli-seconds to several tens of milli-seconds. In other words, this length of time is required before the data to be transmitted (transferred) is prepared. Before the data is prepared, therefore, the SATA interface control circuit 12 need not communicate with the host 20 through the SATA bus 30. If the SATA bus 30 is set in the “IDLE (PHY READY)” mode (the non-power-save state) in accordance with the “BUSY” state of the ATA bus 23 before the data is not prepared, the power is used in vain.

The present embodiment performs operations described below if the data requested by the read command corresponding to the received FIS 31 cannot be transmitted to the HDD 10. First of all, the link/transport layer processing unit 122 of the SATA interface control circuit 12 predicts that the requested data cannot be prepared within a preset time T0. Based on this prediction, the link/transport layer processing unit 122 transmits a “PARTIAL REQUEST” 32 to the SATA bus 30 (Step S5). The “PARTIAL REQUEST” 32 is for setting the SATA bus 30 in the “PARTIAL” mode (the power save state). As a result, the SATA bus 30 is released from the operations performed by the HDD 10 and set in the “PARTIAL” mode.

Thereafter, the link/transport layer processing unit 122 waits for the completion of the preparations made for transmitting the data requested by the read command corresponding to the received FIS (Step S6). After the preparations for transmitting the requested data are completed, the link/transport layer processing unit 122 performs the operations described below in order to transmit the data by way of the SATA bus 30. That is, the link/transport layer processing unit 122 transmits “IDLE REQUEST” 33 to the SATA bus 30 to switch the SATA bus 30 from the “PARTIAL” mode to the “IDLE” mode (Step S7). As a result, the SATA bus 30 is released from the operations performed by the HDD 10 and set in the “IDLE” mode. Whether or not the preparations for the transmission of the requested data have been completed can be determined by detecting the generation of an interrupt indicating the data transfer start. The interrupt is supplied, for example, from the HDC 119 to the link/transport layer processing unit 122 of the SATA interface control circuit 12. The interruption is generated when the requested data is read out from the disk 111 and stored in the buffer RAM 120. As long as the requested data is stored in the buffer RAM 120, the interrupt described above is immediately generated in response to the read command.

After the link/transport layer processing unit 122 switches the SATA bus 30 back to the “IDLE” mode in response to the “IDLE REQUEST” 33, the processing of step S8 is performed. In this Step, the link/transport layer processing unit 122 transmits the data (read data), which is trasferred thereto from the HDC 119 by way of the ATA bus 13, to the host 20 by way of the SATA bus 30. A specific FIS 34 referred to as “Data Payload FIS” is used for this transmission. After all data is transmited to the host 20, the link/transport layer processing unit 122 notifies the host 20 of the command (read command) execution result obtained in the HDD 10 (Step S9). A specific FIS 35 referred to as “Register-Device to Host FIS” is used for this notification. In the present embodiment, the command executin result obtained in the HDD 10 is stored in the status register 119a. In Step S9, therefore, the contents of the status register 119a are set in the FIS 35 and transmitted to the host 20.

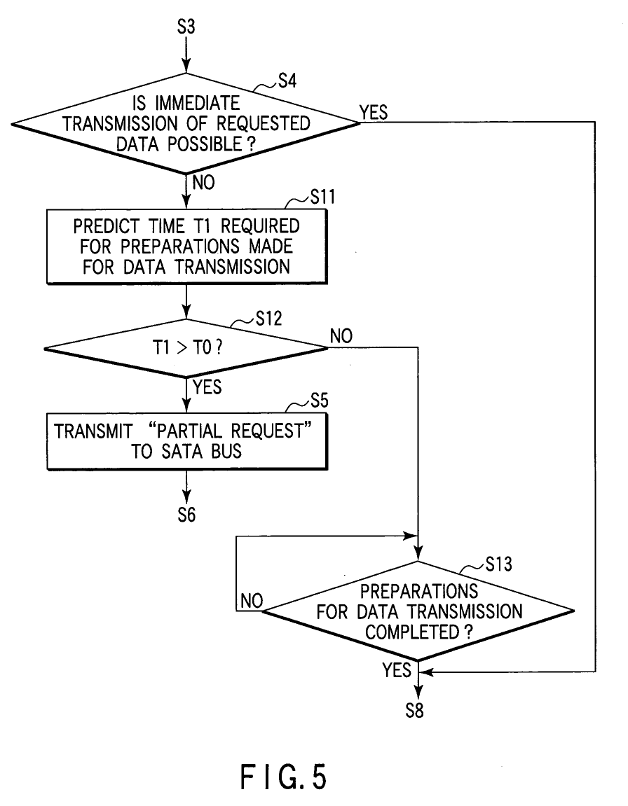

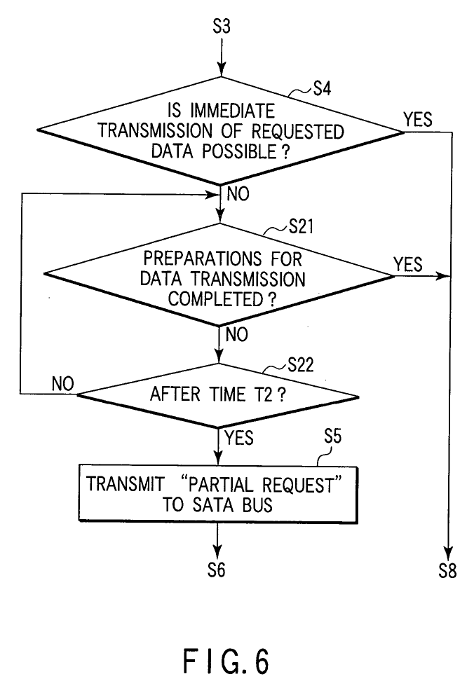

When the head 112 is already on the target track, no seek operation is required, and the requested data can be prepared in a comparatively short time. In consideration of the time required for switching from the “PARTIAL mode”, it is not necessarily efficient to set the SATA bus 30 in the “PARTIAL” mode. With this in mind, the operations illustrated in the flowchart shown in FIG. 5 or 6 may be used, replacing the operation illustrated in the flowchart shown in FIG. 4. In FIGS. 5 and 6, only those operations which are different from those shown in FIG. 4 are illustrated. Reference should be made to FIG. 4 as well, when necessary.

In the example of the flowchart of FIG. 5, a check is made to see whether or not the HDD 10 can immediately transmit the requested data to the host 20 (Step S4). If the HDD 10 cannot transmit the requested data immediately, the link/transport layer processing unit 122 predicts time T1 in which the requsted data can be prepared (Step S11). Time T1 can be predicted by calculating a seek time on the basis of the position of the track on which the head 112 is presently located and the position of the target track to which the head 112 is to be moved. Time T1 can be predicted based on the seek time. After predicting time T1, the link/transport layer processing unit 122 determines whether the predicted time T1 is after preset time T0 (Step S12). Only where the predicated time T1 is after preset time T0, does the link/trasport layer processing unit 122 set the SATA bus 30 in the “PARTIAL” mode (Step S5). Where the predicted time T1 is not after time T0, the link/transport layer processing unit 122 waits for the requested data to be prepared (Step S13). When the requested data has been prepared, the link/transport layer processing unit 122 transmits it to the host 20 by way of the SATA bus 30 by use of FIS 34 (Step S8).

In the example of the flowchart of FIG. 6, a check is made to see whether or not the HDD 10 can immediately transmit the requested data to the host 20 (Step S4). If the HDD 10 cannot transmit the requested data immediately, the link/transport layer processing unit 122 determines that T2 is the time limit by which the requested data has to be prepared (T2<T0) (Steps S21 and S22). Only where the preparations for the transmission of the requested data cannot be completed after time T2 (whicn means that no interrupt for starting the data transfger is generated), does the link/trasport layer processing unit 122 set the SATA bus 30 in the “PARTIAL” mode (Step S5). On the other hand, where the preparations for transmitting the requested data are completed before time T2, the link/transport layer processing unit 122 transmits the requested data to the host 20 by way of the SATA bus 30 by use of FIS 34 (Step S8).

(2) The Case where the Command Involves Data Transfer, and Data Indicating the Type of Data Transfer is Sent from the HDD 10 to the Host 20 Prior to the Data Transfer

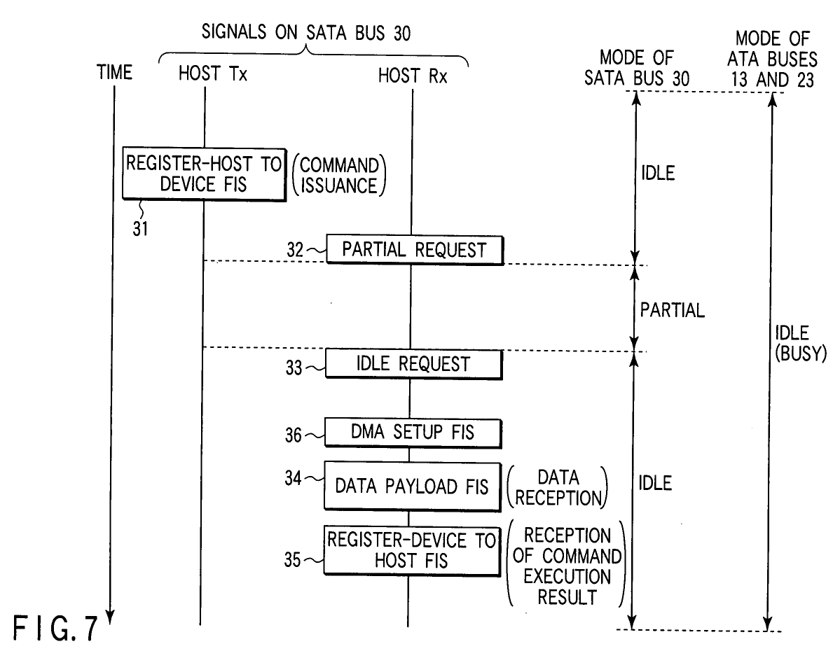

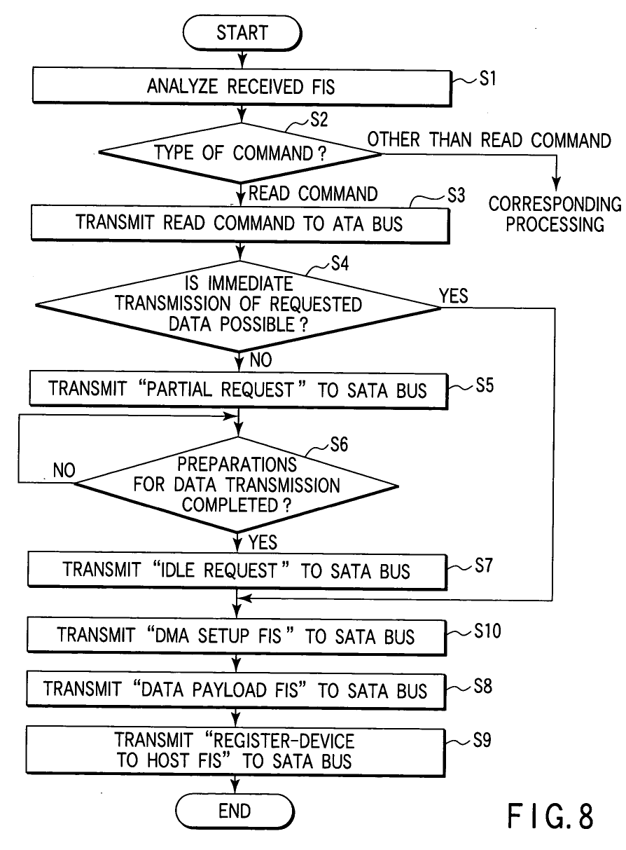

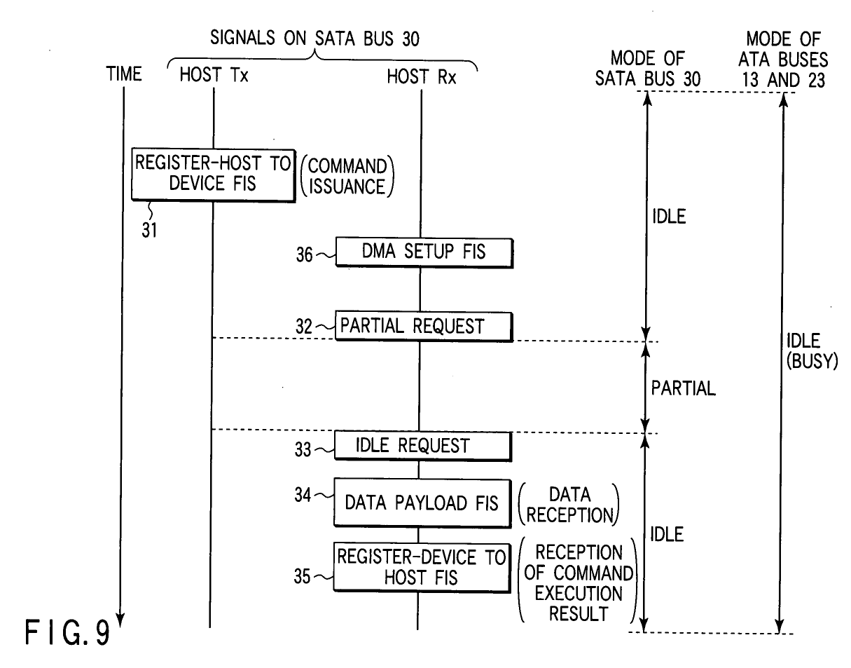

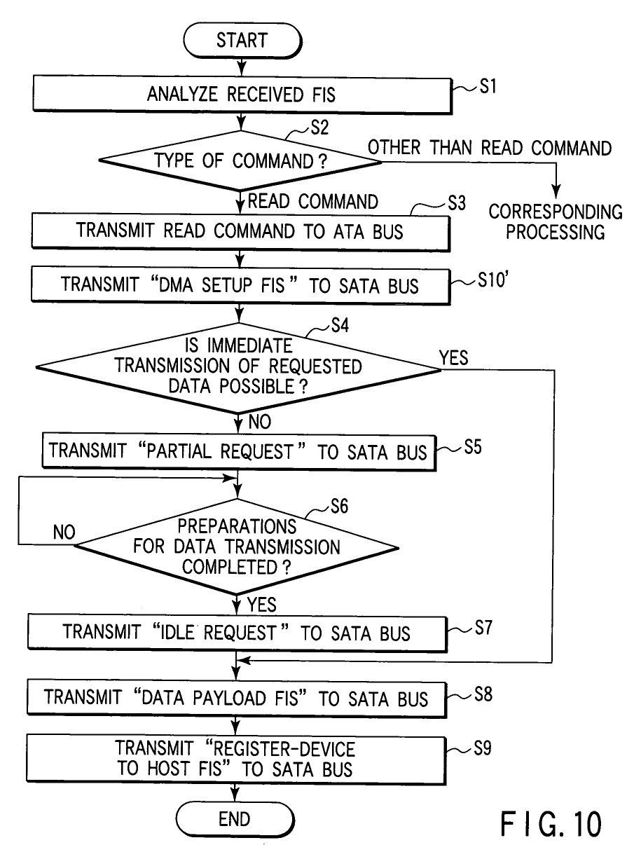

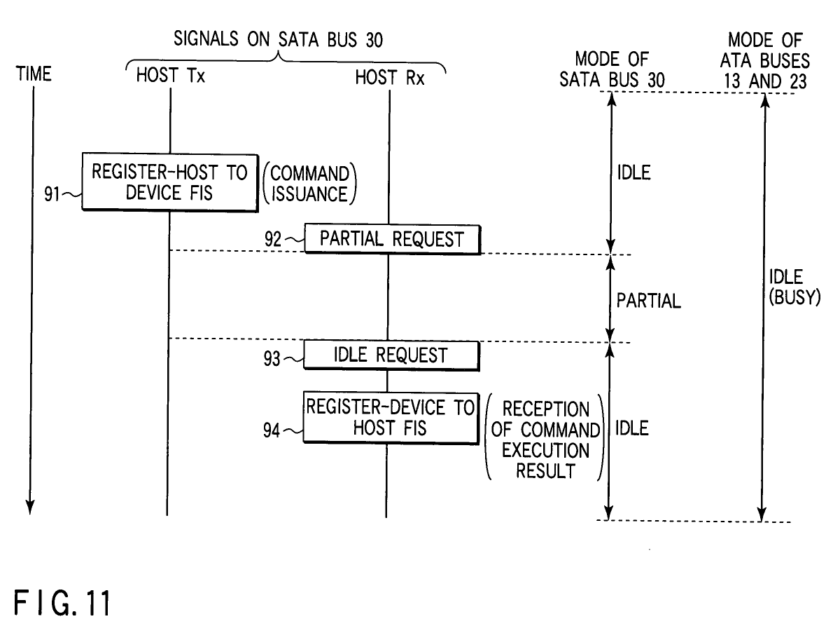

A description will be given of case (2), referring to the case where the command involving data transfer is a read command. The description will be given with reference to the sequence chart of FIG. 7, the flowchat of FIG. 8, the sequence chart of FIG. 9, and the flowchart of FIG. 10. In FIGS. 7 and 9, the same descriptions as those of FIG. 3 are indicated by the same reference numerals as used in FIG. 3. In FIGS. 10 and 11, the same descriptions as those of FIG. 4 are indicated by the same reference numerals as used in FIG. 4. In the data transfer using the SATA bus 30, a data sender may have to instruct what operations are needed by a data recipient. The instructions are sent from the data sender to the data recipient by use of a specific FIS before the data is actually transmitted, and the instructions include identification of the type of data transfer. In the SATA standards, a “PIO Setup FIS” and a “DMA Setup FIS” are defined for notifying the type of data transfer. The former FIS is used for the notification of a programmed input/output (PIO) protocol, and the latter FIS is used for the notification of a DMA (first Party DMA) protocol. The PIO protocol indicates the type of data transfer performed at the initiative of the host 20.

“Data Payload FIS” may be transmitted before the transmission of data as a FIS for notification of the type of data. If the type of data transfer has to be notified, either the technology shown in FIGS. 7 and 8 or the technology show in FIGS. 9 and 10 is applicable to the control technology used in the “PARTIA” mode. In FIGS. 7-10, “DMA Setup FIS” is used as FIS 36 for notification of the type of data transfer.

In the sequence chart of FIG. 7 and the flowchart of FIG. 8, step S10 (wherein a FIS (“DMA Setup FIS”) 36 is transmitted from the SATA interface control circuit 12 to the host 20) is executed immidiately before Step S8 (wherein FIS (“Data Payload FIS”) 35 is transmitted). In the case shown in FIGS. 7 and 8, the SATA interface control ciorcuit 12 transmits “PARTIAL REQUEST” 32 to set the SATA bus 30 in the “PARTIAL” mode (Steps S1 through S5) immediately after a FIS (“Register-Host to Device FIS”) 31 is received from the host 20 (this operation is performed when the preparations for data transmission have not yet been made). In this respect, the case shown in FIGS. 7 and 8 is simialr to the case illustrated in the sequence chart of FIG. 3 and the flowchart of FIG. 4.

In the sequence chart of FIG. 9 and the flowchart of FIG. 10, Step S10′ is executed (wherein a FIS (“DMA Setup FIS”) 36 is transmitted from the SATA interface control circuit 12 to the host 20) in response to the reception of a FIS (“Register-Host to Device FIS”) 31 (Steps S1 to S3). In the case shown in FIGS. 9 and 10, the SATA interface control circuit 12 transmits “PARTIAL REQUEST” 32 to set the SATA bus 30 in the “PARTIAL” mode (Step S5) immediately after the execution of Step S10′ (wherein a FIS (“DMA Setup FIS”) 36 is transmitted) (this operation is performed when the preparations for data transmission have not yet been made). The operations illustrated in FIGS. 7-10 are also performed when “PIO Setup FIS” is used for the notification of the type of data transfer.

(3) The Case where the Command does not Involve Data Transfer and the Host 20 is Notified of Only a Command Execution Result from the HDD 10

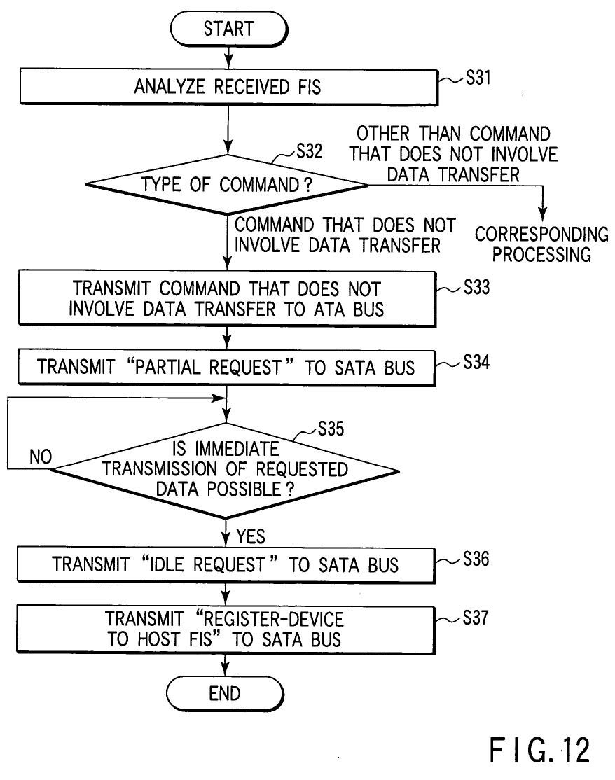

In connection with cases (1) and (2), reference was made to the way in which the “PARTIAL” mode is controlled during the execution of a command involving data transfer. However, the system shown in FIG. 1 is capable of executing a command that does not involve data transfer. A motor actuation command for actuating the SPM 113 of the HDD 10 is an example of such a command. A description will therefore be given as to how operations are performed when the host 20 issues a command that does not involve data transfer. The description will be given, referring to the sequence chart of FIG. 11 and the flowchart of FIG. 12. Let us assume that a command conforming to the ATA standards and addressed to the HDD 10 is supplied from the main host unit 21 of the host 20 to the ATA bus 23, and that the command does not involve data transfer (a typical example of such a command is a motor actuation command). The command on the ATA bus 23 is received by the SATA interface control circuit 22 of the host 20. The link/transport layer processing unit 222 of the SATA interface control circuit 22 converts the command it receives into a specific FIS (“Register-Host to Device FIS”) 91. The FIS (“Register-Host to Device FIS”) 91 is transmitted to the HDD 10 by way of the SATA bus 30.

The SATA interface control circuit 12 of the HDD 10 receives the FIS (“Register-Host to Device FIS”) 91 transmitted thereto through the SATA bus 30. The link/transport layer processing unit 122 of the SATA interface control circuit 12 analyzes the received FIS 91 and determines whether the FIS 91 has been obtained by conversion from a command that does not involve data transfer (Steps S31 and S32). If this is the case, the link/transport layer processing unit 122 converts the received FIS 91 into a command which conforms to the ATA standards and which does not involve data transfer (Step S33). The command is received by the main HDD unit 11 of the HDD 10 and executed by the main HDD unit 11. During the period between the time when the command is received and the time when the host 20 is notified of the command execution result obtained by executing that command, the SATA bus 30 need not be kept in the “IDLE” mode (the non-power-save state).

After step S33 described above is executed, the link/transport layer processing unit 122 transmits “PARTIAL REQUEST” 92 to the SATA bus 30 (Step S34). Owing to this, the SATA bus 30 can be set in the “PARTIAL” mode by the HDD 19. Let us assume that the command execution result transmitted to the ATA bus 13 is set in the status register 119a of the HDC 119 thereafter. In this case, the link/transport layer processing unit 122 determines that the execution of the command has ended and the host 20 can now be notified of the command execution result (Step S35). Based on this determination, the link/transport layer processing unit 122 transmits “IDLE REQUEST” 93 to the SATA bus 30 to switch the SATA bus 30 from the “PARTIAL” mode to the “IDLE” mode (Step S36). After the SATA bus 30 is switched back to the “IDLE” mode on the basis of the “IDLE REQUEST” 93, the link/transport layer processing unit 122 executes Step S37. In this step, the link/transport layer processing unit 122 transmits the command execution result, indicated by the status register 119a, to the host by way of the SATA bus 30, using a specific FIS 94 referred to as “Register-Device to Host FIS.”

In the embodiment described above, the SATA interface control circuit 12 performs all control of setting the SATA bus 30 in the “PARTIAL” mode in accordance with the way in which a command the host 20 issues to the HDD 10 is executed. However, this control may be realized by permitting either the HDC 119 of the main HDD unit 11 or the CPU 130 to control the SATA interface control circuit 12. The embodiment described above is directed to a system equipped with an HDD (hard disk drive). However, the present invention is also applicable to a system equipped with a disk drive other than the HDD, such as an optical disk drive, magneto-optical disk drive, etc. It is sufficient if only the disk drive has a SATA interface. Furthermore, the present invention is applicable to a system equipped with an external storage device other than disk drives, such as a magnetic tape device. In this case as well, it is sufficient if only the external storage device has a SATA interface. The present invention is further applicable to a system equipped with an electronic device other than a disk drive, if only the electronic device has a SATA interface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic device provided with a serial ATA interface and connected to another electronic device through the serial ATA bus, the electronic device comprising:
a determination device configured to determine whether immediate transmission of data is possible when the data should be transmitted to said another electronic device;
a first mode switching device configured to switch the serial ATA bus from a non power saving mode to a specific power saving mode when the immediate transmission of the data from the electronic device is determined to be impossible and the data is predicted as not being prepared within a preset time; and
a second mode switching device configured to switch the serial ATA bus from the specific power saving mode to the non power saving mode after preparations are made for transmission of the data where the first mode switching device switches the serial ATA bus to the specific power saving mode.

2. The electronic device according to claim 1, wherein:
standards of the serial ATA interface define two power saving modes which differ from each other in restoration times to the non power saving mode; and
the first mode switching device selects a power saving mode having a shorter restoration time from the two power saving modes and uses the selected power saving mode as the specific power saving mode.

3. The electronic device according to claim 1, further comprising:
a data transmission device configured to transmit the data to said another electronic device by way of the serial ATA bus by use of a specific frame information in a state where the serial ATA bus is set in the non power saving mode, wherein
when the immediate transmission of the data is possible, the data transmission device transmits the data immediately, and
when the immediate transmission of the data is impossible, the data transmission device starts transmission of the data after preparations for transmission of the data have been made and the second mode switching device switches the serial ATA bus to the non power saving mode.

4. The electronic device according to claim 3, wherein:
the determination device determines whether or not the immediate transmission of the data is possible, when a first frame information is transmitted to the electronic device from said another electronic device and where the first frame information requests data; and
the data transmission device transmits requested data by use of a second frame information, which is the specific frame information.

5. The electronic device according to claim 4, further comprising:
a transfer type notification device configured to transmit a third frame information, used for notification of a transfer type of the data, to said another electronic device by way of the serial ATA bus before the data transmission device transmits the data by use of the second frame information,
wherein the first mode switching device switches the serial ATA bus from the non power saving mode to the specific power saving mode before the third frame information is transmitted to said another electronic device.

6. The electronic device according to claim 4, further comprising:
a transfer type notification device configured to transmit a third frame information, used for notification of a transfer type of the data, to said another electronic device by way of the serial ATA bus,
wherein the first mode switching device switches the serial ATA bus from the non power saving mode to the specific power saving mode after the third frame information is transmitted to said another electronic device and before the data transmission device transmits data by use of the second frame information.

7. The electronic device according to claim 4, further comprising:
an execution result notification device configured to notify said another electronic device of an execution result by way of the serial ATA bus by use of a preset frame information after a designated operation is executed, where the first frame information is transmitted from said another electronic device to the electronic device and the first frame information designates an operation that does not involve data transfer,
wherein the first mode switching device switches the serial ATA bus from the non power saving mode to the specific power saving mode before said another electronic device is notified of the execution result corresponding to the designated operation.

8. The electronic device according to claim 1, further comprising:
a prediction device configured to predict a time required for making preparations for transmission of the data where the determination device determines that the immediate transmission of the data is impossible,
wherein the first mode switching device switches the serial ATA bus from the non power saving mode to the specific power saving mode where the time predicated by the prediction device after the preset time.

9. The electronic device according to claim 1, further comprising:
a monitor device configured to check whether preparations made for transmitting the data have been completed and continues this checking within a second time, which is shorter than a first time used as the preset time, where the determination device determines the immediate transmission of the data is impossible,
wherein the first mode switching device assumes that the data cannot be prepared within the first time and switches the serial ATA bus from the non power saving mode to the specific power saving mode, where the preparations for transmitting the data are not completed even after elapse of the second time.

10. The electronic device according to claim 1, wherein:
the electronic device is an external storage device comprising a recording medium in which data is recorded; and
said another electronic device is a host system that uses the external storage device.

11. A method, applied to an electronic device having a serial ATA interface, for saving power consumed by the serial ATA interface, the electronic device being connected to another electronic device through the serial ATA bus, the method comprising:
determining whether immediate transmission of data is possible when the data should be transmitted to said another electronic device; and
switching the serial ATA bus from a non power saving mode to a specific power saving mode when the immediate transmission of the data from the electronic device is determined to be impossible and the data is predicted as not being prepared within a preset time.

12. The method according to claim 11, further comprising:
waiting for completion of preparations for transmission of the data and then switching the serial ATA bus back to the non power saving mode, where the serial ATA bus is switched to the specific power saving mode; and
waiting for the serial ATA bus to be switched back to the non power saving mode and then transmitting the data to said another electronic device by way of the serial ATA bus by use of a preset frame information, where the serial ATA bus is switched to the specific power saving mode.

13. The method according to claim 12, wherein:
the electronic device becomes ready for transmitting the data to said another electronic device when said another electronic device transmits a first frame information to the electronic device and the first frame information requests data; and
the data requested by the first frame information is transmitted by use of a second frame information, which is the preset frame information.

14. The method according to claim 13, further comprising:
transmitting a third frame information, used for notification of a transfer type of the data, to said another electronic device by way of the serial ATA bus, before the data is transmitted by use of the second frame information,
wherein the serial ATA bus is switched to the specific power saving mode before the third frame information is transmitted to said another electronic device.

15. The method according to claim 13, further comprising:
transmitting a third frame information, used for notification of a transfer type of the data, to said another electronic device by way of the serial ATA bus,
wherein the serial ATA bus is switched to the specific power saving mode after the third frame information is transmitted to said another electronic device and before the data is transmitted by use of the second frame information.

16. The method according to claim 13, further comprising:
notifying said another electronic device of an execution result by way of the serial ATA bus by use of a preset frame information after a designated operation is executed, where the first frame information is transmitted from said another electronic device to the electronic device and the first frame information designates an operation that does not involve data transfer,
wherein the serial ATA bus is switched to the specific power saving mode before said another electronic device is notified of the execution result corresponding to the designated operation.
